(19) United States
(12) Patent Application Publication
(10) Pub. No.: US 2025/0046163 A1
(43) Pub. Date: Feb. 6, 2025

(54) EVACUATION GUIDANCE APPARATUS AND EVACUATION GUIDANCE METHOD

(71) Applicant: TOSHIBA TEC KABUSHIKI KAISHA, Tokyo (JP)

(72) Inventor: Yusuke Sato, Shizuoka Shizuoka (JP)

(21) Appl. No.: 18/625,242

(22) Filed: Apr. 3, 2024

(30) Foreign Application Priority Data
Aug. 2, 2023 (JP) 2023-126165

(51) Int. Cl. G08B 7/06; G01S 5/02; G08B 21/02

(52) U.S. Cl. CPC G08B 7/066; G01S 5/0231; G08B 21/02

(57) ABSTRACT

An evacuation guidance apparatus includes a server and one or a plurality of information terminals capable of moving in a commercial facility and capable of communicating with the server. The information terminal includes an emitting unit configured to emit specifying information for specifying a position of the information terminal including the emitting unit. The server includes a specifying unit configured to specify a position of the information terminal in the commercial facility, a receiving unit configured to receive an emergency signal emitted from an emission apparatus, a determining unit configured to determine evacuation guidance routes for each of the information terminals, and a transmitting unit configured to transmit evacuation guidance route information including information concerning the determined evacuation guidance routes to the information terminals, and the information terminal includes a displaying unit configured to display an evacuation guidance route included in the evacuation information received from the server.

### CROSS-REFERENCE TO RELATED APPLICATION

This application is based upon and claims the benefit of priority from Japanese Patent Application No. 2023-126165, filed on Aug. 2, 2023, the entire contents of which are incorporated herein by reference.

### FIELD

Embodiments described herein relate generally to an evacuation guidance apparatus and an evacuation guidance method.

### BACKGROUND

Recently, in commercial facilities including stores such as a shopping center, a volume retail store, and a department store, the number of store clerks and the like working in a commercial facility tends to decrease because of on-going labor shortage, work efficiency, and the like. Therefore, if an emergency such as a disaster occurs in the commercial facility, it is sometimes difficult for store clerks and the like to safely guide customers in the commercial facility.

### BRIEF DESCRIPTION OF THE DRAWINGS

FIG. 1 is a diagram illustrating a system according to an embodiment;

FIG. 2 is a diagram illustrating a cart and an information terminal attached to the cart;

FIG. 3 is a sequence chart illustrating a flow of processing in an evacuation guidance apparatus;

FIG. 4 is a block diagram illustrating a hardware configuration of the information terminal;

FIG. 5 is a block diagram illustrating a hardware configuration of a server;

FIG. 6 is a memory map illustrating a configuration of an information terminal managing unit;

FIG. 7 is a diagram illustrating a map in a store;

FIG. 8 is a block diagram illustrating a hardware configuration of a checkout machine;

FIG. 9 is a functional block diagram illustrating a functional configuration of the evacuation guidance apparatus;

FIG. 10 is a flowchart illustrating a flow of control processing of the information terminal;

FIG. 11 is a diagram in which occurrence of an emergency and an example of an evacuation guidance route are displayed on the information terminal;

FIG. 12 is a flowchart illustrating a flow of processing of the server;

FIG. 13 is a diagram in which a moving state of the information terminal after the emergency occurrence is displayed on the server; and

FIG. 14 is a flowchart illustrating a flow of control processing of the checkout machine.

### DETAILED DESCRIPTION

An aspect of embodiments is to provide an evacuation guidance apparatus and an evacuation guidance method capable of safely guiding customers if an emergency occurs.

An evacuation guidance apparatus in an embodiment is an evacuation guidance apparatus including: a server; and one or a plurality of information terminals capable of moving in a commercial facility and capable of communicating with the server, wherein the information terminal includes an emitting unit configured to emit specifying information for specifying a position of the information terminal including the emitting unit, the server includes: a specifying unit configured to specify, based on the specifying information, a position of the information terminal in the commercial facility; a receiving unit configured to receive an emergency signal emitted from an emission apparatus; a determining unit configured to, if the emergency signal is received, determine evacuation guidance routes for each of the information terminals based on the specified position of the information terminal; and a transmitting unit configured to transmit evacuation guidance route information including information concerning the determined evacuation guidance routes to the information terminals, and the information terminal includes a displaying unit configured to display, on a display unit, an evacuation guidance route included in the evacuation guidance route information received from the server.

An embodiment is explained below with reference to the drawings. In the embodiment, a store such as a shopping center, a volume retailer, or a department store is explained as an example of a commercial facility. An information terminal is explained as being attached to a shopping cart (hereinafter simply referred to as “cart”) capable of freely moving in the store. In the embodiment, the position of an information terminal 7 in the store is specified, as an example, by being detected by a plurality of beacons provided near passages in a store T. Note that embodiments are not limited by the embodiment explained below.

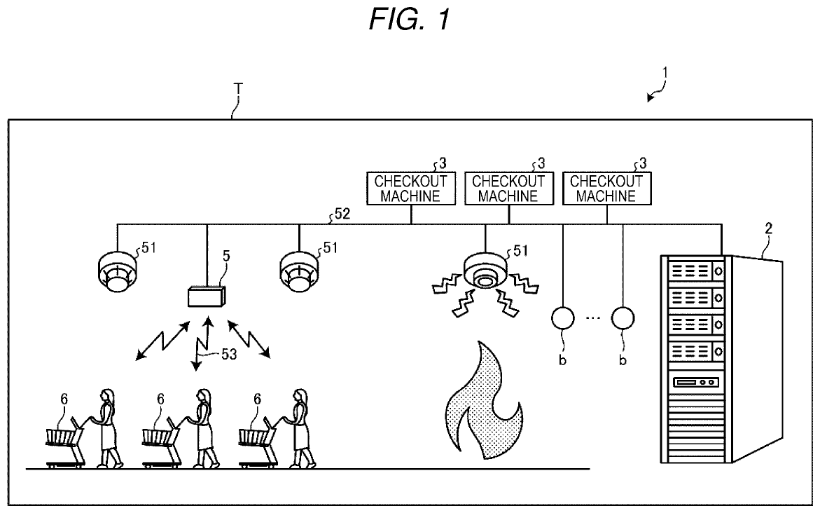

FIG. 1 is a diagram illustrating a system according to the embodiment. In FIG. 1, a system 1 is installed in the T such as a supermarket, a volume retailer, a convenience store, or a specialty store. The system 1 includes, for example, a server 2 that is a store server, an information terminal 7 attached to a cart 6, and a checkout machine 3 (an emission apparatus). Besides, a fire alarm 51 (an emission apparatus) that senses and informs occurrence of fire and a beacon b may be included in the system 1. Note that, in the embodiment, the server 2 and the information terminal 7 configure an evacuation guidance apparatus 4.

The server 2, the checkout machine 3, the fire alarm 51, and the beacon b are connected to one another by a communication line 52 such as a LAN (Local Area Network). The information terminal 7 located in the store T is connectable by a wireless communication line 53 such as a wireless LAN via one or a plurality of repeaters 5 (wireless access points) connected to the communication line 52. If the information terminal 7 is connected to the communication line 52 via the wireless communication line 53 and the repeater 5, the information terminal 7 is capable of communicating with the server 2 and the checkout machine 3. Note that, as the communication line 52 and the wireless communication line 53, the Internet, a VPN (virtual private network), a LAN, a public communication network, a mobile communication network, and the like can be used independently or in combination as appropriate.

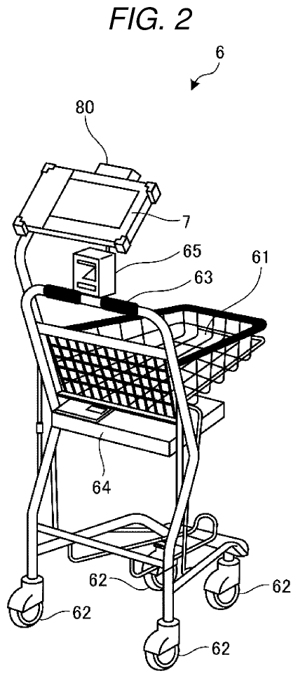

The cart 6 and the information terminal 7 are explained. FIG. 2 is a diagram illustrating the cart 6 and the information terminal 7 attached to the cart 6.

The cart 6 is capable of moving in the store T. The cart 6 includes a storing section 61, casters 62, a handle 63, and a battery 64. Commodities to be purchased are placed on the storing section 61. Alternatively, a shopping basket or the like in which commodities to be purchased by a customer are put is placed on the storing section 61. The casters 62 are provided in, for example, four places of the bottom of the cart 6 and rotate to enable the cart 6 to move in the front, rear, left, and right directions. The customer grips the handle 63 if moving the cart 6. The customer grips the handle 63 and operates (pushes and pulls) the cart 6 to move the cart 6 in the store T. The battery 64 is a storage battery that is mounted on the cart 6 and supplies electric power to a scanner 65 explained below. The battery 64 may supply electric power to the information terminal 7 or may function as a battery for charging the information terminal 7.

In the cart 6, a scanner 65 is attached to, for example, the handle 63. The scanner 65 images a commodity and reads a code symbol such as a barcode or a two-dimensional code attached to the commodity. Alternatively, the scanner 65 optically reads the code symbol. The scanner 65 decodes the read code symbol and acquires commodity specifying information of the commodity.

The scanner 65 may perform general object recognition for the commodity imaged by the scanner 65 to recognize the commodity and acquire the commodity specifying information of the commodity. Note that, in the embodiment, the scanner 65 is explained as an apparatus separate from the information terminal 7. However, if a camera is incorporated in the information terminal 7, the camera may be used instead of the scanner 65. In this case, the scanner 65 is unnecessary.

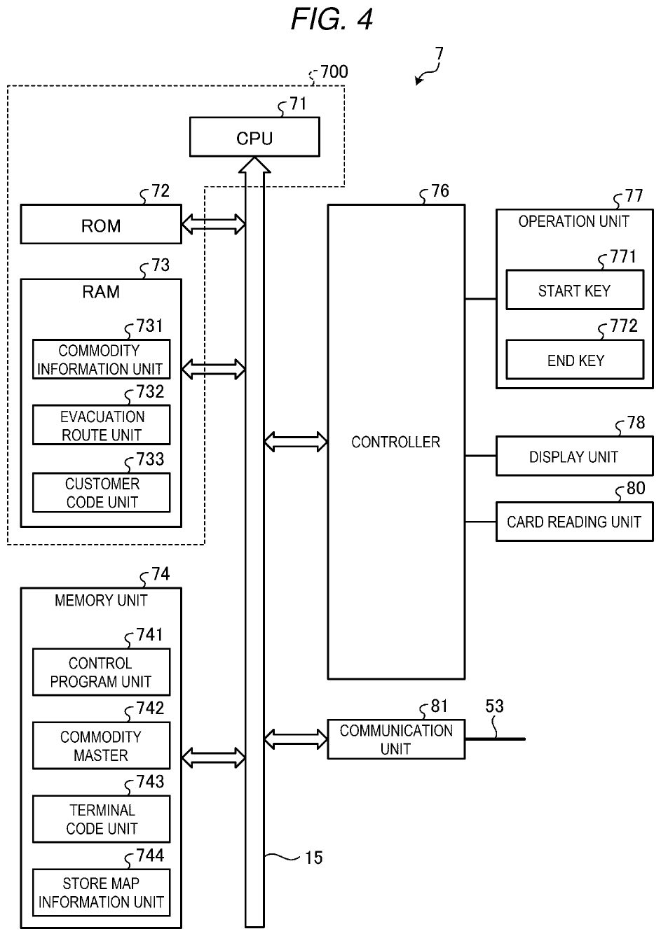

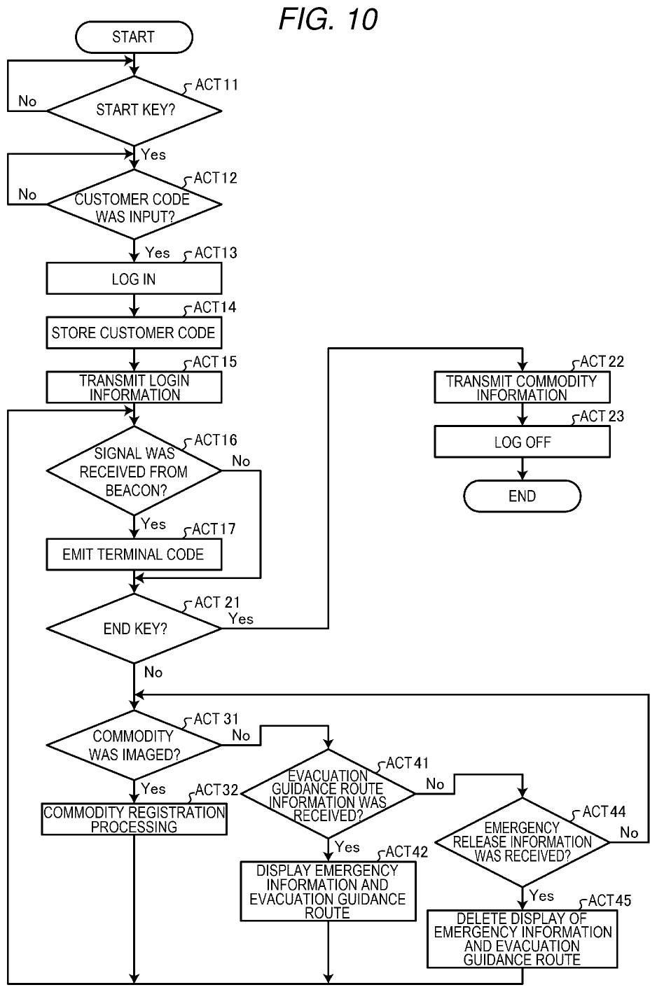

The information terminal 7 is attached to the cart 6. The information terminal 7 is a small information terminal configured by a microcomputer such as a smartphone, a tablet terminal, or a PDA (Personal Digital Assistance). The information terminal 7 has a hardware configuration explained below with reference to FIG. 4. Application software for executing control explained below with reference to FIG. 10 is installed in the information terminal 7.

The commodity specifying information of the commodity read by the scanner 65 is input to the information terminal 7 from the scanner 65. The information terminal 7 executes commodity registration processing relating to the commodity. The commodity registration processing means processing for reading, based on the read commodity specifying information, commodity information (a commodity name, a commodity price, and the like) of the commodity and displaying the commodity information on a display unit 78 (see FIG. 4) and storing the commodity information in a commodity information unit 731 (see FIG. 4).

The information terminal 7 transmits the commodity information stored in the commodity information unit 731 to the server 2.

If being logged in, the information terminal 7 emits a terminal code (specifying information) for specifying the information terminal 7 if receiving a radio wave from the beacon b explained below. The beacon b installed near the information terminal 7 receives the emitted terminal code. If an emergency occurs in the store T, an evacuation guidance route for the information terminal 7 (that is, a customer operating the cart 6 to which the information terminal 7 is attached) to evacuate from a current position to an exit of the store T is displayed on the information terminal 7. If a plurality of information terminals 7 are present in the store T, the evacuation guidance route for evacuation is sometimes different depending on positions in the store T of the respective information terminals 7. Therefore, evacuation guidance routes for guidance to exits closest to the information terminals 7 are displayed on each of the information terminals 7.

The customer operating the cart 6 can safely evacuate to the outside of the store T from the exit by pushing and moving the cart 6 along the evacuation guidance route displayed on the information terminal 7.

Referring back to FIG. 1, the beacons b are respectively installed in all passages where carts 6 in the store T pass. Each of the beacons b emits a radio wave used in short range wireless communication within a range of several meters to several tens meters around the beacon b and communicates with the information terminal 7 located within the range. Specifically, the beacon b emits a feeble radio wave that reaches within the range of several meters to several tens meters. The information terminal 7 entering the range receives the radio wave emitted by the beacon b. If receiving the radio wave, the information terminal 7 emits a radio wave including a terminal code for specifying the information terminal 7. The beacon 6 receives the radio wave emitted from the information terminal 7 to receive the terminal code. Note that the beacon b recognizes the intensity of the received radio wave. That is, the beacon b recognizes that the information terminal 7 located closer to the beacon b more intensely received the radio wave. The beacon b transmits a beacon code for specifying the beacon b, the received terminal code, and information concerning the intensity the received radio wave (hereinafter collectively referred to as “beacon information”) to the server 2 via the communication line 52.

Note that the beacon b repeatedly emits radio waves at a predetermined time interval. The beacon b transmits the beacon information relating to the terminal code received according to the emission, the intensity of the radio wave, and the beacon code to the server 2 every time. Therefore, if the information terminal 7 is moving, the received terminal code and the intensity of the radio wave change every time.

Fire alarms 51 are installed in a plurality of parts on the ceiling of the store T. If fire (an emergency) occurs in the store T, each of the fire alarms 51 senses the fire (flame and smoke) and transmits an emergency signal indicating that the fire occurred to the server 2 via the communication line 52. If transmitting the emergency signal, the fire alarm 51 transmits the emergency signal together with an alarm code for specifying the fire alarm 51 itself.

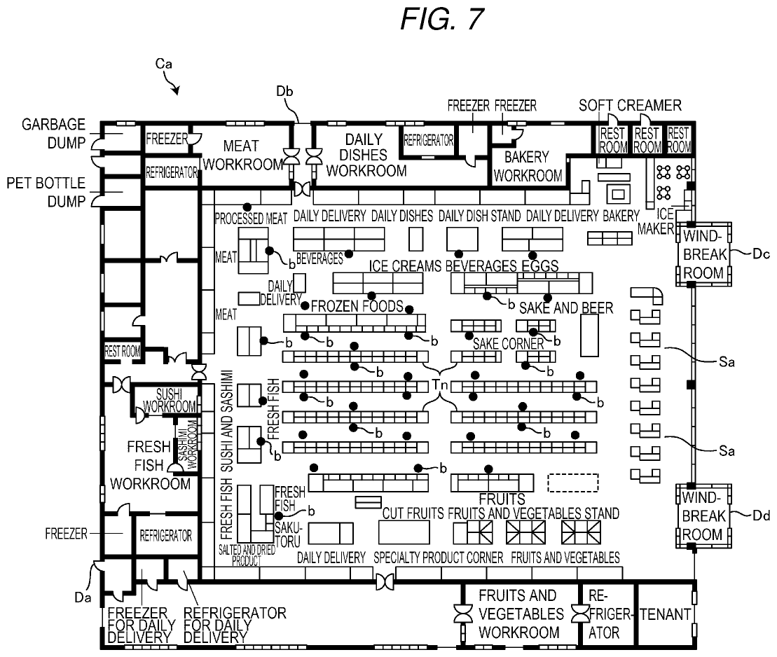

One or a plurality of checkout machines 3 are installed in a checkout area Sa (see FIG. 7) of the store T. The checkout machine 3 executes checkout processing for a commodity subjected to the commodity registration processing in the information terminal 7. Specifically, the checkout machine 3 executes the checkout processing based on commodity information received from the information terminal 7 directly or through the server 2. The checkout processing means, for example, processing for displaying a total amount of commodities and a tax amount relating to one transaction subjected to the commodity registration processing and, if payment is made by cash, calculating change based on a deposit deposited from a customer and displaying the change and processing for dispensing a receipt on which the commodity information and settlement information (the total mount, a deposit amount, a change mount, and the like) are printed. The checkout machine 3 transmits the commodity information and the checkout information (collectively referred to as “sales data”) of the commodity subjected to the checkout processing to the server 2.

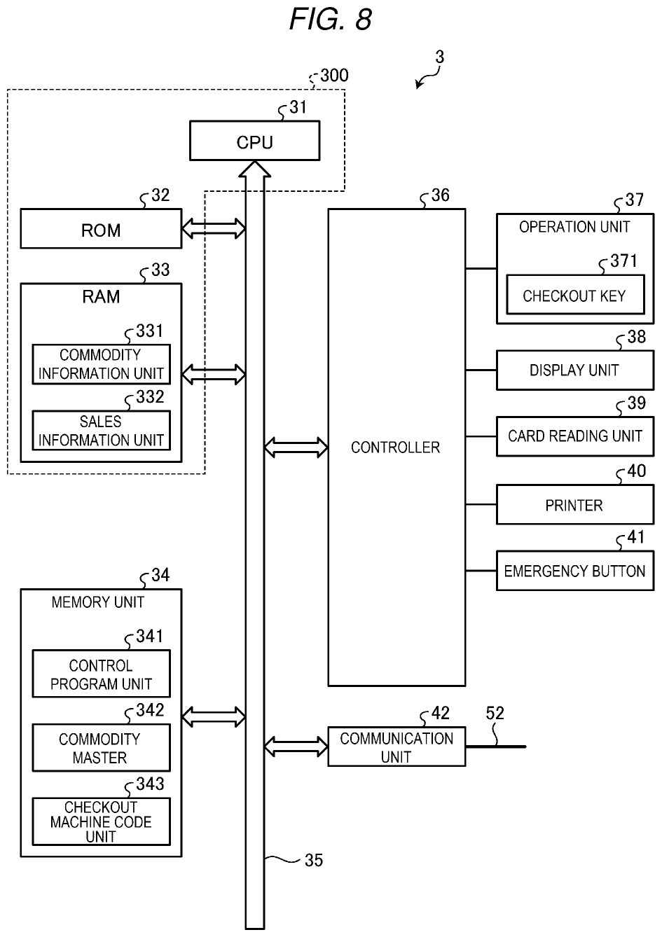

Each of the checkout machines 3 includes an emergency button 41 (see FIG. 8). A store clerk such as a casher operates the emergency button 41 if an emergency (for example, a robbery) occurred in the checkout machine 3. If the emergency button 41 is operated, the checkout machine 3 transmits an emergency signal to the server 2 via the communication line 52. If transmitting the emergency signal, the checkout machine 3 transmits the emergency signal to the server 2 together with a checkout machine code for specifying the checkout machine 3 itself.

The server 2 is installed in, for example, a back office of the store T. The server 2 receives, from the checkout machines 3, sales data of commodities subjected to the checkout processing in the checkout machines 3 and accumulates the sales data and manages sales information of the store T.

The server 2 grasps the positions of a plurality of information terminals 7 moving in the store T (that is, the positions of the carts 6). The server 2 receives beacon information including a terminal code from the beacon b and specifies the position of the information terminal 7 specified by the terminal code. Specifically, the server 2 receives beacon information from the plurality of beacons b. The server 2 compares the intensities of radio waves received from the beacons b and determines that the information terminal 7 specified by the terminal code is located in the position of the beacon b having the highest intensity of the received radio wave. If as many beacons b as possible are disposed in the store T, the server 2 can determine a more accurate position of the information terminal 7. In this way, the server 2 specifies the position of the information terminal 7.

Note that, since the terminal code and the intensity of the radio wave received by the server 2 change every time according to the movement of the information terminal 7, the server 2 recognizes that the position of the information terminal 7 determined based on the received terminal code and intensity of the radio wave is changed. That is, since the server 2 can grasp the position of the moving information terminal 7 in real time, the server 2 can determine whether the information terminal 7 moved or stayed in the site for a predetermined time or more.

If the fire alarm 51 operates, the server 2 receives, from the fire alarm 51, an emergency signal involved in fire and an alarm code for specifying the fire alarm 51. The server 2 recognizes, based on the received emergency signal, that an emergency (the fire) occurred. The server 2 recognizes (specifies), based on the receive alarm code, a place (an area) where the emergency occurred in the store T.

If the emergency button 41 is operated, the server 2 receives, from the checkout machine 3 in which the emergency button 41 is operated, an emergency signal and a checkout machine code for specifying the checkout machine 3. The server 2 recognizes, based on the received emergency signal, that an emergency (for example, a robbery) occurred. The server 2 recognizes (specifies), based on the received checkout machine code, a place (an area) where the emergency occurred in the store T.

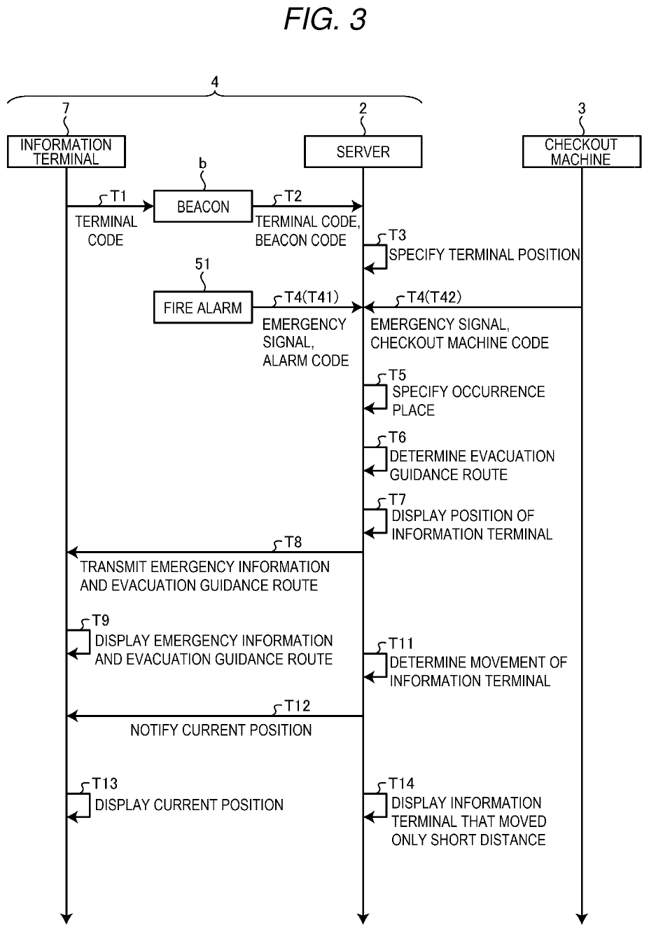

Next, a flow of processing relating to the evacuation guidance apparatus 4 and the checkout machine 3 is explained. FIG. 3 is a sequence chart illustrating the flow of the processing in the evacuation guidance apparatus 4 and the checkout machine 3. As illustrated in FIG. 3, the evacuation guidance apparatus 4 in the embodiment includes the server 2 and the information terminal 7.

The information terminal 7 receives a radio wave emitted by the beacon b and emits a terminal code for specifying the information terminal 7 itself (T1). The beacon b transmits beacon information including the received terminal code, the intensity of the radio wave, and beacon information including a beacon code for specifying the beacon b to the server 2 (T2). The server 2 receiving the beacon information specifies that the position of the beacon b that emitted a terminal code having the largest radio wave intensity is the position of the information terminal 7 that emitted the terminal code (T3). The processing in T1 to T3 is repeatedly executed every time the beacon b emits a radio wave at a predetermined time interval. Therefore, the server 2 can grasp the positions in the store T of all the logged-in information terminals 7 (position information (for example, coordinate information in the store T) of the information terminals 7) substantially in real time.

If the fire alarm 51 senses fire or if the emergency button 41 is operated, the server 2 receives an emergency signal (T4). If receiving the emergency signal and an alarm code from the fire alarm 51 (T41), the server 2 determines that an emergency (the fire) occurred. If receiving an emergency signal and a checkout machine code from the checkout machine 3 (T42), the server 2 determines that an emergency (for example, a robbery) occurred. The server 2 specifies, based on the received alarm code, a place (an area) where the fire occurred (T5). The server 2 specifies, based on the received checkout machine code, a place (an area) where the emergency occurred (T5).

Subsequently, the server 2 determines (creates), based on the grasped position information (coordinates) of the information terminals 7, position information (a coordinate) of the place where the emergency occurred, and position information (coordinates) of the information terminals 7 and closest exits, for each of the information terminals 7, an evacuation guidance route for evacuating the information terminal 7 to the closest exit. In determining the evacuation guidance route, the server 2 determines the evacuation guidance route to avoid the place where the emergency occurred.

The server 2 determines an evacuation guidance route, for example, as explained below. The server 2 calculates distances between the position (the coordinate) of the information terminal 7 and the positions (the coordinates) of a plurality of exits and determines, for each of the information terminals 7, an evacuation guidance route at the shortest distance among evacuation guidance routes through which the information terminal 7 can evacuate without passing the occurrence place of the emergency. Alternatively, the server 2 creates, in advance, in various positions in the store T, a large number of candidates of evacuation guidance routes from the positions to the exits for each of places where emergencies occurred and determines an optimum evacuation guidance route from the created candidates based on the positions (the coordinates) of the information terminals 7 at a point in time when an emergency signal is received and a place (a coordinate) where an emergency occurs. Note that the evacuation guidance route is not limited to the above description and may be determined using other methods.

The server 2 stores a store map (see FIG. 7) indicating a layout of passages and the like in the store T and displays the current positions in the store T of the information terminals 7 specified in T3 (T7). The server 2 transmits, to the logged-in information terminals 7 in the store T, via the communication line 52, the repeater 5, and the wireless communication line 53, emergency information indicating that the emergency occurred and evacuation guidance route information including a position indicating the place where the emergency occurred, the current positions of the information terminals 7 in the store T, and evacuation guidance routes of the information terminals 7 from the positions of the information terminals 7 to the exits (T8).

The information terminals 7 display the evacuation guidance routes based on the received evacuation guidance route information to be superimposed on the store map (T9). Customers operating the carts 6 can safely evacuate toward the exits by moving the carts 6 along the evacuation guidance routes displayed on the information terminals 7.

Even after transmitting the evacuation guidance route information to the information terminals 7, the server 2 grasps the positions of the information terminals 7 in real time based on beacon information received from the beacons b. After transmitting the evacuation guidance route information, the server 2 determines to which degree the information terminals 7 (that is, the carts 6) moved (specifically, whether the information terminals 7 moved or substantially stayed in the sites after the evacuation guidance route information was transmitted) (T11). The server 2 transmits, for each of the information terminals 7, evacuation guidance route information including the current positions of the information terminals 7 (T12). The information terminals 7 display the current positions of the information terminals 7 based on the received evacuation guidance route information (T13). In this way, the customers evacuating together with the carts 6 can grasp the current positions in the store T and can determine whether the customers successfully correctly evacuate along the evacuation guidance routes.

The server 2 displays, based on the determination in T11, the information terminal 7 that did not substantially move (stayed in the site or moved only a very short distance) after the evacuation guidance route information was transmitted (T14). The server 2 determines, based on whether the information terminal 7 moved a predetermined distance or more within a predetermined time after the transmission of the evacuation guidance route information, whether the information terminal 7 moved or did not substantially move. The processing in T11 to T14 is repeatedly performed many times after the evacuation guidance route information was transmitted.

Next, a hardware configuration of the information terminal 7 is explained. FIG. 4 is a block diagram illustrating the hardware configuration of the information terminal 7. As illustrated in FIG. 4, the information terminal 7 includes a CPU (Central Processing Unit) 71, which is an example of a processor, a ROM (Read Only Memory) 72, a RAM (Random Access Memory) 73, and a memory unit 74. The CPU 71 is a control entity of the information terminal 7. The ROM 72 stores various programs. Programs and various data are loaded in the RAM 73. The memory unit 74 stores various programs. The CPU 71, the ROM 72, the RAM 73, and the memory unit 74 are connected to one another via a bus 75. The CPU 71, the ROM 72, and the RAM 73 configure a control unit 700. That is, the CPU 71 operates according to a control program (including application software) stored in the ROM 72 or the memory unit 74 and loaded in the RAM 73, whereby the control unit 700 executes control processing of the information terminal 7 explained below.

The RAM 73 includes a commodity information unit 731, an evacuation route unit 732, and a customer code unit 733. The commodity information unit 731 stores commodity information of a commodity subjected to commodity registration processing. The evacuation route unit 732 stores emergency information received from the server 2 and evacuation guidance route information for the information terminal 7. The customer code unit 733 stores a customer code of a customer used to log in to the information terminal 7.

The memory unit 74 is configured by a nonvolatile memory such as an HDD (Hard Disc Drive) or a flash memory in which stored information is retained even if a power supply is shut off. The memory unit 74 includes a control program unit 741 that stores a control program (including installed application software) for causing the information terminal 7 to operate, a commodity master 742, a terminal code unit 743, and a store map information unit 744. The commodity master 742 stores commodity information of commodities for each of the commodities in association with commodity specifying information for specifying the commodities. The terminal code unit 743 stores a terminal code (terminal specifying information) for specifying the information terminal 7. The store map information unit 744 stores map information indicating a layout in the store T that is planarly viewed. The map information displays the positions of display shelves in the store T, includes information for displaying, on the information terminal 7, which commodities are displayed in which positions, and is information capable of displaying, on the information terminal 7, passages through which the cart 6 passes. The customer moving the cart 6 can cause the information terminal 7 to display the map information and check a display position of a desired commodity and a passage to the position.

The control unit 700 is connected to an operation unit 77, a display unit 78, and a card reading unit 80 via the bus 75 and a controller 76.

The operation unit 77 includes a start key 771 and an end key 772. The start key 771 is operated to input a customer code in order to log in to the information terminal 7. For example, a customer operating the cart 6 operates the start key 771. The end key 772 is operated to log off from the information terminal 7. For example, the customer operates the end key 772. The display unit 78 displays commodity information of a commodity subjected to commodity registration processing. The display unit 78 displays the emergency information and the evacuation guidance route information received from the server 2 and stored in the evacuation route unit 732 to be superimposed on the map information stored in the store map information unit 744 to display the emergency and the evacuation guide route. The card reading unit 80 reads (acquires) card information including a customer code from a scanned or inserted customer card.

The control unit 700 is connected to a communication unit 81 via the bus 75. The communication unit 81 is communicably connected to the server 2 and the checkout machine 3 via the wireless communication line 53, the repeater 5, and the communication line 52.

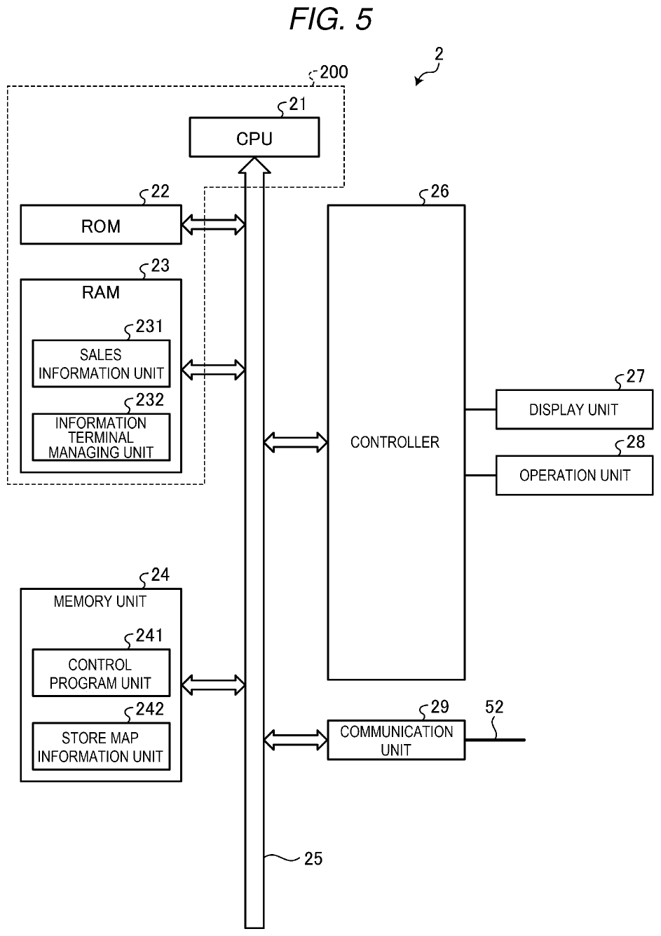

Next, a hardware configuration of the server 2 is explained. FIG. 5 is a block diagram illustrating the hardware configuration of the server 2. As illustrated in FIG. 5, the server 2 includes a CPU 21, which is an example of a processor, a ROM 22, a RAM 23, and a memory unit 24. The CPU 21 is a control entity of the server 2. The ROM 22 stores various programs. Programs and various data are loaded in the RAM 23. The memory unit 24 stores various programs. The CPU 21, the ROM 22, the RAM 23, and the memory unit 24 are connected to one another via a bus 25. The CPU 21, the ROM 22, and the RAM 23 configure a control unit 200. That is, the CPU 21 operates according to a control program stored in the ROM 22 or the memory unit 24 and loaded in the RAM 23, whereby the control unit 200 executes control processing of the server 2 explained below.

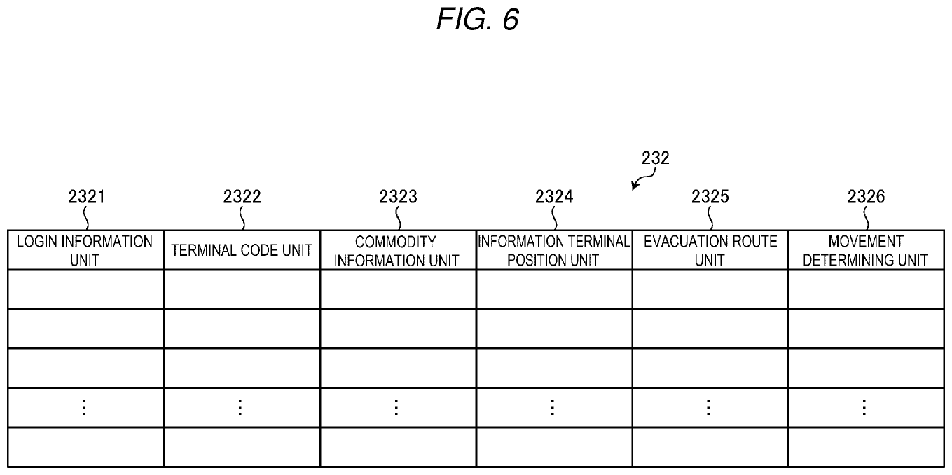

The RAM 23 includes a sales information unit 231 and an information terminal managing unit 232. The sales information unit 231 cumulatively stores sales data received from the checkout machine 3 and manages sales of the store T. The information terminal managing unit 232 manages information of the logged-in information terminal 7 including the position of the information terminal 7 in the store T. The information terminal managing unit 232 is explained below with reference to FIG. 6.

The memory unit 24 is configured by a nonvolatile memory such as an HDD or a flash memory in which stored information is retained even if a power supply is shut off. The memory unit 24 includes a control program unit 241 and a store map information unit 242. The control program unit 241 stores a control program for driving the server 2. The store map information unit 242 stores the same map information as the map information stored by the store map information unit 744.

The control unit 200 is connected to a display unit 27 and an operation unit 28 via the bus 25 and a controller 26. The display unit 27 is, for example, a liquid crystal display and displays information to an operator who operates the server 2. The operation unit 28 is, for example, a keyboard and is operated by the operator of the server 2.

The control unit 200 is connected to a communication unit 29 (a receiving unit) via the bus 25. The communication unit 29 is communicably connected to the checkout machine 3, the beacon b, the fire alarm 51, and the repeater 5 via the communication line 52. The communication unit 29 is communicably connected to the information terminal 7 via the repeater 5.

Next, the information terminal managing unit 232 is explained. FIG. 6 is a memory map illustrating a configuration of the information terminal managing unit 232. As illustrated in FIG. 6, the information terminal managing unit 232 includes a login information unit 2321, a terminal code unit 2322, a commodity information unit 2323, an information terminal position unit 2324, an evacuation route unit 2325, and a movement determining unit 2326.

The login information unit 2321 receives, from the information terminal 7, a customer code read from a customer card used to log in to the information terminal 7 and stores the customer code. The terminal code unit 2322 receives, from the information terminal 7, a terminal code for specifying the information terminal 7 logged in with the customer code stored in the login information unit 2321 and stores the terminal code. The commodity information unit 2323 receives, according to operation of the end key 772, from the information terminal 7, commodity information of a commodity subjected to commodity registration processing in the information terminal 7 having the terminal code stored in the terminal code unit 2322 and stores the commodity information. The information terminal position unit 2324 stores information concerning the position (the coordinate) of the information terminal 7 having the terminal code specified based on the beacon information received from the beacon b (in T3 in FIG. 3) and stored in the terminal code unit 2322. The evacuation route unit 2325 stores the evacuation guidance route information and the emergency information relating to the evacuation guidance route of the information terminal 7 having the terminal code determined in T6 in FIG. 3 if the emergency occurs and stored in the terminal code unit 2322. The movement determining unit 2326 determines presence or absence of the information terminal 7 that did not move or the information terminal 7 that did not substantially move after the evacuation guidance route information was transmitted to the information terminal 7 (T11 in FIG. 3). The control unit 200 stores information (for example, flag information) indicating that the information terminal 7 did not substantially move in the movement determining unit 2326 corresponding to a terminal code of the information terminal 7 that did not substantially move. The information terminal 7, for which information of a flag “1” is stored in the movement determining unit 2326, indicates that the information terminal 7 that did not substantially move after the emergency information was transmitted. The information terminal 7, for which information of a flag “O” is stored in the movement determining unit 2326, indicates that the information terminal 7 moved after the emergency information was transmitted.

Next, an example of a map displayed on the display unit 78 by the map information stored by the store map information unit 744 of the information terminal 7 is explained. FIG. 7 is a diagram illustrating a map in the store T displayed on the display unit 78. As illustrated in FIG. 7, installation positions of display shelves in the store T, selling floors where commodities are sold, passages in the store T, and the like are displayed in map display Ca planarly representing a layout in the store T displayed on the display unit 78. A checkout area Sa where the checkout machines 3 are installed and exits (represented by Da, Db, Dc, and Dd) from the store T to the outside are displayed in the map display Ca.

Note that, although not actually displayed in the map display Ca, the beacons b are attached to the display shelves at each predetermined distance (for explanation, the beacons b are displayed in FIG. 7). Actually, since the beacons b more than those illustrated in FIG. 7 are provided at predetermined intervals in the store T, it is possible to accurately grasp the position of the information terminal 7.

The information terminal 7 receives, from the server 2, information concerning a specified position of the information terminal 7 itself and plots the position on the map display Ca, whereby a customer can recognize a position where the customer is present in the store T. Therefore, the customer can grasp a positional relation between a commodity to be purchased and a selling floor and move to the selling floor where the commodity is sold.

Subsequently, a hardware configuration of the checkout machine 3 is explained. FIG. 8 is a block diagram illustrating the hardware configuration of the checkout machine 3. As illustrated in FIG. 8, the checkout machine 3 includes a CPU 31, which is an example of a processor, a ROM 32, a RAM 33, and a memory unit 34. The CPU 31 is a control entity of the checkout machine 3. The ROM 32 stores various programs. Programs and various data are loaded in the RAM 33. The memory unit 34 stores various programs. The CPU 31, the ROM 32, the RAM 33, and the memory unit 34 are connected to one another via a bus 35. The CPU 31, the ROM 32, and the RAM 33 configure a control unit 300. That is, the CPU 31 operates according to a control program stored in the ROM 32 or the memory unit 34 and loaded in the RAM 33, whereby the control unit 300 executes control processing of the checkout machine 3 explained below.

The RAM 33 includes a commodity information unit 331 and a sales information unit 332. The commodity information unit 331 stores commodity information subjected to commodity registration processing received from the information terminal 7 through the server 2. In this embodiment, the commodity information unit 331 receives and stores commodity information once transmitted from the information terminal 7 to the server 2 and stored in the commodity information unit 2323. Specifically, the commodity information unit 331 inquires the server 2 about commodity information based on a customer code read from a customer card by a card reading unit 39 (explained below) of the checkout machine 3. The server 2 searches through the information terminal managing unit 232 based on the received customer code, reads the relevant commodity information from the commodity information unit 2323, and transmits the commodity information to the checkout machine 3. The checkout machine 3 stores the commodity information received from the server 2 in the commodity information unit 331. The sales information unit 332 stores transaction data obtained by performing checkout processing based on the commodity information stored in the commodity information unit 331.

The memory unit 34 is configured by a nonvolatile memory such as an HDD or a flash memory in which stored information is retained even if a power supply is shut off. The memory unit 34 includes a control program unit 341, a commodity master 342, and a checkout machine code unit 343. The control program unit 341 stores a control program for driving the checkout machine 3. The commodity master 342 stores the same information as the information stored by the commodity master 742. The checkout machine code unit 343 stores a checkout machine code for specifying the checkout machine 3.

The control unit 300 is connected to an operation unit 37, a display unit 38, a card reading unit 39, a printer 40, and an emergency button 41 via the bus 35 and a controller 36. The operation unit 37 is a keyboard including a checkout key 371. An operator of the checkout machine 3 operates the operation unit 37. A customer or a store clerk operates the checkout key 371 if performing checkout processing in the checkout machine 3. The display unit 38 is, for example, a liquid crystal display and displays information to the operator who operates the checkout machine 3. Note that the operation unit 37 may be a touch panel provided on the display unit 38. The card reading unit 39 reads a customer code from an inserted or scanned customer card. The printer 40 prints commodity information and checkout information relating to a transaction subjected to checkout processing and dispenses a receipt.

The emergency button 41 is a button attached to the checkout machine 3. For example, if an emergency such as a robbery occurs in the checkout machine 3, a customer, a store clerk, or the like operates the emergency button 41. If the emergency button 41 is operated, the checkout machine 3 transmits an emergency signal to the server 2.

The control unit 300 is connected to a communication unit 42 via the bus 35. The communication unit 42 is communicably connected to the server 2, the beacon b, the fire alarm 51, and the repeater 5 via the communication line 52. The communication unit 42 is communicably connected to the information terminal 7 via the repeater 5.

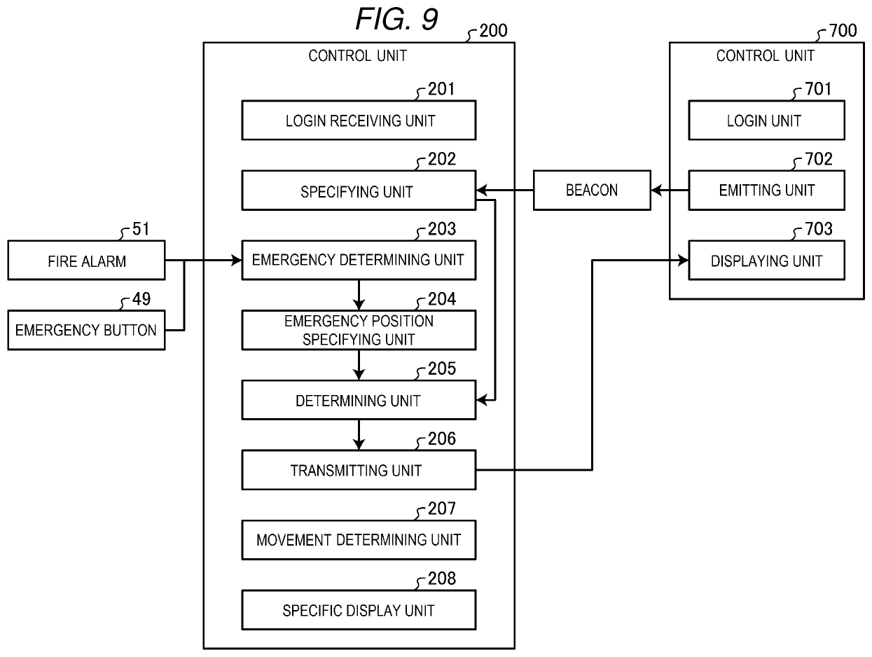

A functional configuration of the evacuation guidance apparatus 4 is explained below. FIG. 9 is a functional block diagram illustrating the functional configuration of the evacuation guidance apparatus 4. The control unit 200 of the server 2 conforms to the control program stored in the ROM 22 or the control program unit 241 of the memory unit 24 to function as a login receiving unit 201, a specifying unit 202, an emergency determining unit 203, an emergency position specifying unit 204, a determining unit 205, a transmitting unit 206, a movement determining unit 207, and a specific display unit 208.

The login receiving unit 201 executes, based on login information including a customer code and a terminal code received from the information terminal 7, login processing relating to the information terminal 7. Specifically, based on the login information received from the information terminal 7, the login receiving unit 201 stores the received customer code in the login information unit 2321 of the information terminal managing unit 232 and stores the received terminal code in the terminal code unit 2322 corresponding thereto. The information terminal 7 having the terminal code stored in the terminal code unit 2322 is assumed to be logged in.

The specifying unit 202 specifies the position of the information terminal 7 in the store T based on beacon information emitted by the beacon b that receives the terminal code (specifying information) emitted from the information terminal 7. Specifically, the specifying unit 202 compares radio wave intensities received from the beacons b and specifies that the position of the beacon b having the highest radio wave intensity of the received terminal code is the position of the information terminal 7.

The emergency determining unit 203 determines whether an emergency occurred in the store T. Specifically, the emergency determining unit 203 determines whether an emergency signal was received from the fire alarm 51. If determining that an emergency signal was received from the fire alarm 51, the emergency determining unit 203 determines that an emergency (fire) occurred in the store T. The emergency determining unit 203 determines whether an emergency signal was received from the checkout machine 3. If determining that an emergency signal was received from the checkout machine 3, the emergency determining unit 203 determines that an emergency (for example, a robbery) occurred in the store T.

The emergency position specifying unit 204 specifies, based on a received alarm code, a place where the emergency occurred. That is, the emergency position specifying unit 204 specifies that a position (a coordinate) of the fire alarm 51 specified by the received alarm code is a place where the emergency occurred. The emergency position specifying unit 204 specifies, based on a received checkout machine code, the place where the emergency occurred. That is, the emergency position specifying unit 204 specifies that a position (a coordinate) of the checkout machine 3 specified by the received checkout machine code is a place where the emergency occurred.

If the emergency signal is received, the determining unit 205 determines an evacuation guidance route for each of the information terminals 7 based on the specified position of the information terminal 7. Specifically, the determining unit 205 determines an evacuation guidance route of the information terminal 7 based on information concerning the position where the emergency occurred, information concerning the position of the information terminal 7 stored in the information terminal position unit 2324, and information concerning the position of an exit closed from the position of the information terminal 7. Note that the determining unit 205 determines an evacuation guidance route that does not pass (or does not approach) a coordinate indicating the place where the emergency occurred. The determining unit 205 stores evacuation guidance route information including the determined evacuation guidance route in the evacuation route unit 2325.

The transmitting unit 206 transmits, to the information terminals 7, the emergency information indicating that the emergency occurred and the evacuation guidance route information including the information concerning the determined evacuation guidance route (that is, the emergency information and the evacuation guidance route information stored in the evacuation route unit 2325).

The movement determining unit 207 determines whether the information terminal 7, to which the transmitting unit 206 transmitted the evacuation guidance route information, substantially moved a predetermined distance or more from the position specified by the specifying unit 202.

Specifically, the movement determining unit 207 determines whether the information terminal 7, to which the transmitting unit 206 transmitted the evacuation guidance route information, moved the predetermined distance or more from the position specified by the specifying unit 202 after the evacuation guidance route information was transmitted.

The specific display unit 208 displays, on the display unit 27, the information terminal 7 determined by the movement determining unit 207 as not having substantially moved the predetermined distance or more. Specifically, the specific display unit 208 highlights and displays, on the display unit 27, the information terminal 7 determined by the movement determining unit 207 as not having substantially moved the predetermined distance or more. If highlighting the information terminal 7, the specific display unit 208 displays the information terminal 7 while being added with a time in which the information terminal 7 did not substantially move.

The control unit 700 of the information terminal 7 conforms to the control program stored in the ROM 72 or the control program unit 741 of the memory unit 74 to function as a login unit 701, an emitting unit 702, and a displaying unit 703.

The login unit 701 inputs a customer code and logs in to the information terminal 7. Specifically, the login unit 701 reads the customer code by causing the card reading unit 80 to read a customer card and makes the information terminal 7 usable.

The emitting unit 702 emits specifying information (a terminal code) for specifying the position of the information terminal 7 including the emitting unit 702. Specifically, if a radio wave is received from the beacon b in a login state, the emitting unit 702 emits a terminal code for specifying the position of the information terminal 7 including the emitting unit 702.

The displaying unit 703 displays, on the display unit 78, the evacuation guidance route received from the server 2. Specifically, the displaying unit 703 displays, based on the evacuation guidance route information received from the server 2, the evacuation guidance route of the information terminal 7 to be superimposed on the map information stored in the store map information unit 744.

Next, control of the information terminal 7 is explained. FIG. 10 is a flowchart illustrating a flow of control processing of the information terminal 7. As illustrated in FIG. 10, the control unit 700 of the information terminal 7 determines whether the start key 771 was operated (Act 11). The control unit 700 stays on standby until the start key 771 is operated (No in Act 11). If determining that the start key 771 was operated (Yes in Act 11), subsequently, the control unit 700 determines whether a customer code was read by the card reading unit 80 (Act 12). The control unit 700 stays on standby until a customer code is read (No in Act 12). If it is determined that a customer code was read (Yes in Act 12), the login unit 701 logs in to the information terminal 7 based on the read customer code (Act 13). The control unit 700 stores the read customer code in the customer code unit 733 (Act 14). The control unit 700 transmits login information (including the customer code and a terminal code) to the server 2 (Act 15).

Subsequently, the control unit 700 determines whether a radio wave emitted by the beacon b at a fixed interval was received (Act 16). If it is determined that a radio wave from the beacon b was received (Yes in Act 16), the emitting unit 702 emits a terminal code for specifying the information terminal 7 stored in the terminal code unit 743 (Act 17). If determining that a radio wave from the beacon b was not received (No in Act 16), the control unit 700 does not execute the processing in Act 17.

After the processing in Act 17 is executed or if it determined No in Act 16, subsequently, the control unit 700 determines whether the end key 772 was operated (Act 21). If determining that the end key 772 was not operated (No in Act 21), the control unit 700 determines whether an image of a commodity captured by the scanner 65 was input from the scanner 65 (Act 31). If determining that an image of a commodity was input (Yes in Act 31), the control unit 700 executes commodity registration processing for the commodity based on the image (Act 32). The control unit 700 returns to Act 16.

If determining that an image was not input from the scanner 65 (No in Act 31), subsequently, the control unit 700 determines whether emergency information and emergency guidance route information were received from the server 2 (Act 41). If it is determined that emergency information and evacuation guidance route information were received from the server 2 (Yes in Act 41), the displaying unit 703 displays, on the display unit 78, the received emergency information, a place where an emergency included in the evacuation guidance route information, a current position of the information terminal 7, and an evacuation guidance route from the current position to be superimposed on the map information stored in the store map information unit 744 (Act 42). The control unit 700 returns to Act 16.

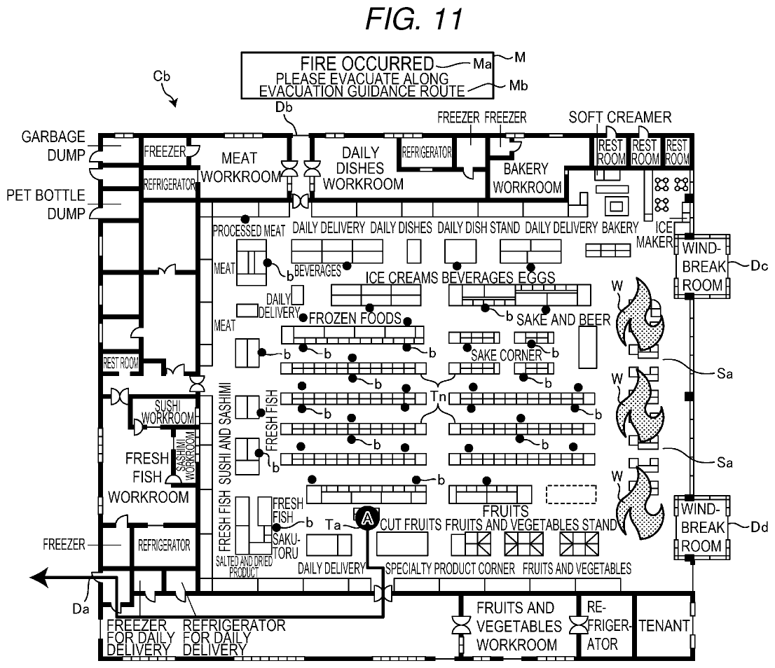

FIG. 11 is a diagram illustrating an example of a screen of the occurrence of the emergency and the evacuation guidance route displayed in the processing in Act 42 by the displaying unit 703. As illustrated in FIG. 11, on a displayed screen Cb, a message M indicating that the emergency occurred is displayed in a conspicuous position (for example, an upper part of the screen Cb). The message M includes a message Ma indicating the occurrence of the emergency and a type of the emergency (in the example illustrated in FIG. 11, a message of “fire occurred”) and a message Mb for calling attention to evacuation along the evacuation guidance route). On the screen Cb, a mark W indicating flame is displayed in a place where the emergency (fire) occurred. In the display example illustrated in FIG. 11, since the mark W is displayed near the checkout area Sa, it is possible to recognize that the emergency occurred near the checkout area Sa.

An evacuation guidance route Ya of a customer A is displayed on the screen Cb. The evacuation guidance route Ya is determined based on a position Ta of the information terminal 7 attached to the cart 6 operated by the customer A in the store T, the place where the emergency occurred, and the position of an exit Da avoiding the occurrence place of the emergency and closest from the position Ta. Note that, on the information terminals 7 of the other customers present in positions different from the position of the customer A, evacuation guidance routes most appropriate for the customers are displayed.

Referring back to FIG. 10, if determining that evacuation guidance route information from the server 2 was not received (No in Act 41), subsequently, the control unit 700 determines whether a release signal for the emergency was received from the server 2 (Act 44). If determining that a release signal for the emergency was not received (No in Act 44), the control unit 700 returns to Act 31. If determining that a release signal for the emergency was received from the server 2 (Yes in Act 44), the control unit 700 deletes the display of the emergency information, the place where the emergency occurred, and the evacuation guidance route relating to the information terminal 7 displayed in Act 42 (Act 45). The control unit 700 returns to Act 16.

If determining in Act 21 that the end key 772 was operated (Yes in Act 21), the control unit 700 transmits commodity information of a commodity subjected to commodity registration processing to the server 2 (Act 22). The control unit 700 logs off from the information terminal 7 (Act 23). The control unit 700 ends the processing.

With the information terminal 7 in the embodiment explained above, the evacuation guidance route necessary for the information terminal 7 to evacuate received from the server 2 is displayed on the display unit 78. Therefore, a customer operating the cart 6 can safely evacuate by moving the cart 6 and evacuating along the displayed evacuation guidance route.

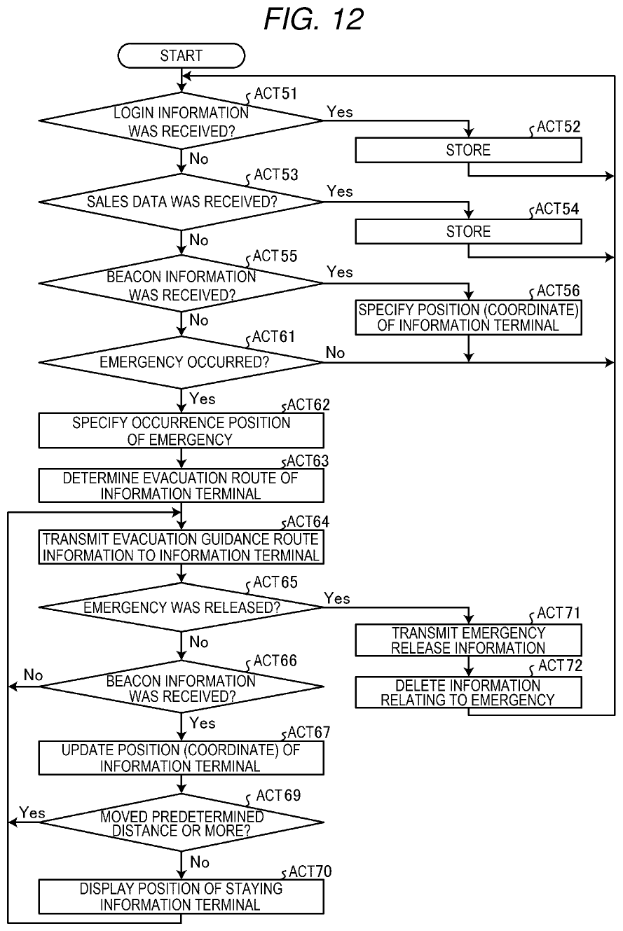

Subsequently, control of the server 2 is explained. FIG. 12 is a flowchart illustrating a flow of processing of the server 2. As illustrated in FIG. 12, the control unit 200 of the server 2 determines if login information was received from the information terminal 7 (Act 51). If it is determined that login information was received from the information terminal 7 (Yes in Act 51), the login receiving unit 201 stores a customer code included in the received login information in the login information unit 2321 and stores a received terminal code in the terminal code unit 2322 (Act 52). The control unit 200 returns to Act 51.

If determining that login information was not received from the information terminal 7 (No in Act 51), the control unit 200 determines whether sales data was received from the checkout machine 3 (Act 53). If determining that sales data was received from the checkout machine 3 (Yes in Act 53), the control unit 200 additionally stores the received sales data in the sales information unit 231 (Act 54). The control unit 200 returns to Act 51.

If determining that sales data was not received from the checkout machine 3 (No in Act 53), the control unit 200 determines whether beacon information was received from the beacon b (Act 55). If it is determined that beacon information was received from the beacon b (Yes in Act 55), the specifying unit 202 specifies, based on a received beacon code, a terminal code, and information concerning the intensity of a radio wave, a position (a coordinate) of the information terminal 7 specified by the terminal code (Act 56). The control unit 200 stores information concerning the specified position of the information terminal 7 in the information terminal position unit 2324. The control unit 200 returns to Act 51.

If it is determined that beacon information was not received from the beacon b (No in Act 55), the emergency determining unit 203 determines whether an emergency occurred in the store T (that is, the store T is in an emergency) (Act 61). If it is determined that an emergency did not occur in the store T (No in Act 61), the control unit 200 returns to Act 51. If it is determined that an emergency occurred in the store T (Yes in Act 61), the emergency position specifying unit 204 specifies a place where the emergency occurred (Act 62). The determining unit 205 determines evacuation guidance routes respectively for the information terminals 7 present in the store T (Act 63). The control unit 200 stores, in the evacuation route unit 2325, evacuation guidance route information including the determined evacuation guidance routes and emergency information. The transmitting unit 206 transmits the emergency information and the evacuation guidance route information including the determined evacuation guidance routes to the information terminals 7 (Act 64).

Subsequently, the control unit 200 determines whether the emergency was released (Act 65). For example, a manager class person in the store T can release the emergency by performing predetermined operation (for example, operating a release button after inputting a store clerk code of the manager) in the server 2 to emit a release signal for the emergency. If determining that the emergency was not released (No in Act 65), the control unit 200 determines whether beacon information was received from the beacon b after the emission of the evacuation guidance route information (Act 66). If beacon information was not received (No in Act 66), the control unit 200 returns to Act 64. If determining that beacon information was received from the beacon b (Yes in Act 66), the control unit 200 stores new position information of the information terminal 7 in addition to the position of the information terminal 7 stored in the information terminal position unit 2324 and updates the information concerning the position of the information terminal 7 stored in the information terminal position unit 2324 (Act 67). That is, position information of the information 7 specified before and position information of the information terminal 7 specified anew are stored in the information terminal position unit 2324.

Subsequently, the movement determining unit 207 determines, based on the new and old position information of the information terminal 7 stored in the information terminal position unit 2324, whether the information terminal 7 (that is, the cart 6 to which the information terminal 7 is attached) moved a predetermined distance or more (Act 69). The predetermined distance is a distance determined in advance and is a distance at which it is possible to recognize that the information terminal 7 substantially moved. If it is determined that the information terminal 7 moved the predetermined distance or more (Yes in Act 69), the control unit 200 returns to Act 64. If it is determined that the information terminal 7 did not move the predetermined distance or more (that is, the information terminal 7 did not substantially move) (No in Act 69), the specific display unit 208 displays, on the display unit 27, the position of the information terminal 7 represented by the position information (the coordinate) of the information terminal 7 to be superimposed on the map information stored in the store map information unit 242 while being added with a message indicating that the information terminal 7 (that is, the cart 6) did not substantially move after the emission of the evacuation guidance route information (Act 70). If the information terminals 7 that did not substantially move after the emission of the evacuation guidance route information are present other than the information terminal 7, the specific display unit 208 displays the positions of the information terminals 7 and messages on the same screen of the display unit 27 (Act 70). A manager and a person in charge who look the display can grasp, at a time, the number and the positions of the information terminals 7 staying without moving and a time in which the information terminals 7 did not move.

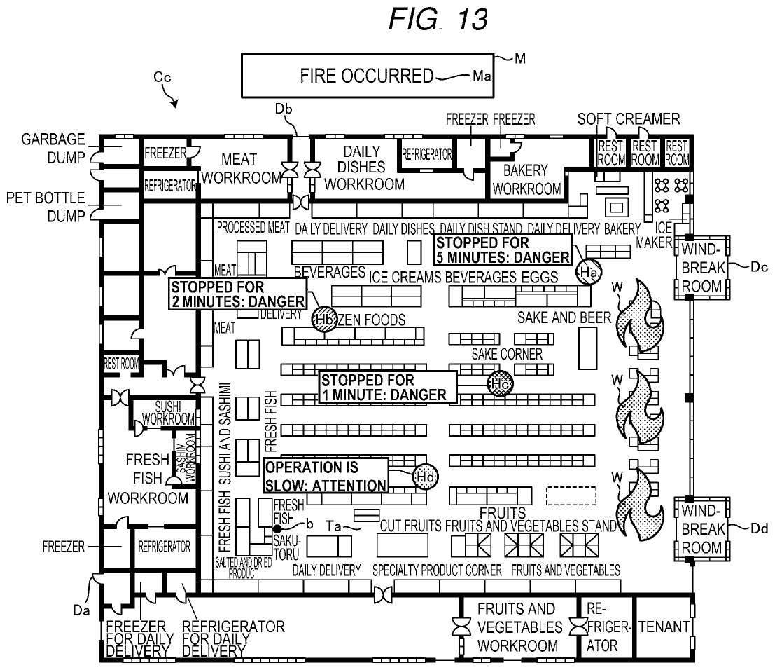

FIG. 13 illustrates an example of the screen displayed on the display unit 27 by the specific display unit 208 in Act 70. In FIG. 13, the information terminals 7 that did not substantially move after the emission of the evacuation guidance route information are displayed in four places of a position Ha, a position Hb, a position Hc, and a position Hd. Messages indicating times in which the information terminals 7 stayed and degrees of dangers adjusted to the staying times are displayed in positions near the respective information terminals 7. The person in charge or the like who looks at the messages determines a customer present together with which information terminal 7 should be preferentially saved.

Referring back to FIG. 12, on the other hand, if determining in Act 65 that the emergency was released (Yes in Act 65), the control unit 200 transmits an emergency release signal to the information terminals 7 (Act 71). The control unit 200 deletes the information relating to the emergency (for example, the information stored in the evacuation route unit 2325 and the movement determining unit 2326) (Act 72). The control unit 200 also deletes the screen displayed on the display unit 27 in Act 70. The control unit 200 returns to Act 51.

With the server 2 in the embodiment explained above, evacuation guidance routes for each of customers (each of the information terminals 7) are determined based on the positions of the information terminals 7, a place where an emergency occurred, and the positions of the exits.

Therefore, it is possible to safely guide the customers to the exits for each of the customers. Since the positions of the information terminals 7 that did not substantially move after the evacuation guidance route information was transmitted are displayed, a store clerk and the like are capable of moving to the information terminals 7 to save the customers.

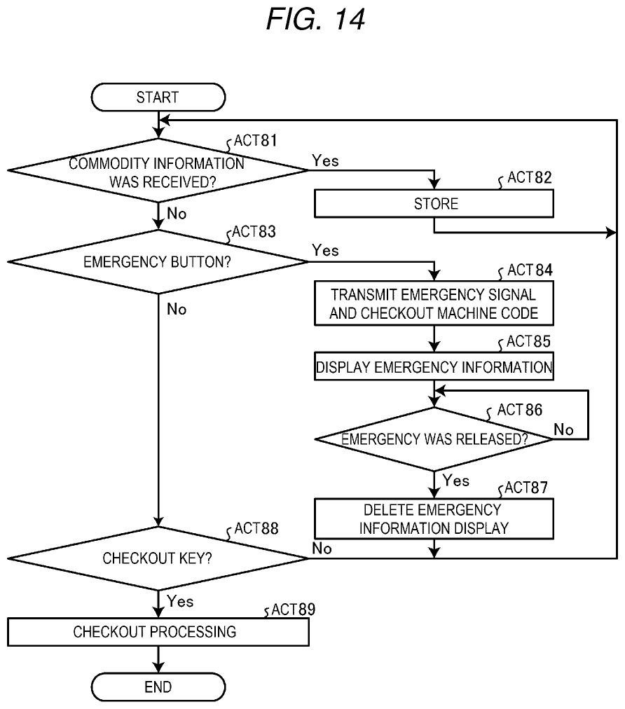

Control of the checkout machine 3 is explained below. FIG. 14 is a flowchart illustrating a flow of control processing of the checkout machine 3. As illustrated in FIG. 14, the control unit 300 of the checkout machine 3 determines whether commodity information of a commodity subjected to commodity registration processing in the information terminal 7 was received from the server 2 (Act 81). Specifically, in the checkout machine 3, if a customer code is read by the card reading unit 39, the control unit 300 transmits the customer code and the checkout machine code stored in the checkout machine code unit 343 to the server 2 in correlation with each other. The server 2, which received the customer code and the checkout machine code, transmits commodity information stored in the commodity information unit 2323 in association with the received customer code to the checkout machine 3 specified by the checkout machine code. In Act 81, the control unit 300 determines whether commodity information was received from the server 2. If determining that commodity information was received (Yes in Act 81), the control unit 300 stores the commodity information in the commodity information unit 331 (Act 82). The control unit 300 returns to Act 81.

If determining that commodity information was not received (No in Act 81), the control unit 300 determines whether the emergency button 41 was operated (Act 83). If determining that the emergency button 41 was operated (Yes in Act 83), the control unit 300 transmits an emergency signal and the checkout machine code stored in the checkout machine code unit 343 to the server 2 in correlation with each other. The control unit 300 displays, on the display unit 38, emergency information indicating that an emergency occurred (Act 85).

Subsequently, the control unit 300 determines whether the emergency was released (an emergency release signal was received from the server 2) (Act 86). The control unit 300 stays on standby until the emergency is released (No in Act 86). If determining that the emergency was released (Yes in Act 86), the control unit 300 deletes the display of the emergency information displayed in Act 85 (Act 87). The control unit 300 returns to Act 81.

If determining that the emergency button 41 was not operated (No in Act 83), the control unit 300 determines whether the checkout key 371 was operated (Act 88). If the checkout key 371 was not operated, the control unit 300 returns to Act 81. If determining that the checkout key 371 was operated (Yes in Act 88), the control unit 300 executes checkout processing relating to the transaction based on the commodity information stored in the commodity information unit 331 (Act 89). The control unit 300 stores sales data of a commodity subjected to the checkout processing in the sales information unit 332. The control unit 300 returns to Act 81.

As explained above, the evacuation guidance apparatus 4 in the embodiment is the evacuation guidance apparatus 4 configured by the server 2 and the one or the plurality of information terminals 7 movable in the store T and communicable with the server 2. The information terminal 7 includes the emitting unit 702 that emits specifying information for specifying the position of the information terminal 7 including the emitting unit 702. The server 2 includes the specifying unit 202 that specifies the position of the information terminal 7 in the store T based on the specifying information, the communication unit 29 that receives an emergency signal emitted from the fire alarm 51 or the checkout machine 3, the determining unit 205 that, if the emergency signal is received, determines evacuation guidance routes for each of the information terminals 7 based on the specified position of the information terminal 7, and the transmitting unit 206 that transmits evacuation guidance route information including information concerning the determined evacuation guidance routes to the information terminals 7. The information terminal 7 includes the displaying unit 703 that displays, on the display unit 78, the evacuation guidance routes included in the evacuation guidance route information received from the server 2.

In the evacuation guidance apparatus 4 in the embodiment explained above, the server 2 determines respective evacuation guidance routes suitable for evacuating from the positions of the information terminals 7 and transmits the evacuation guidance routes to the information terminals 7 present in the store T. The information terminals 7 display the evacuation guidance routes on the displays 78. Therefore, if an emergency occurs, it is possible to safely guide customers.

The embodiment is explained above. However, the embodiment is present as an example and is not intended to limit the scope of the invention. The embodiment can be implemented in other various forms. Various omissions, substitutions, changes, and combinations can be made without departing from the gist of the invention. The embodiment and modifications thereof are included in the scope and the gist of the invention and included in the scope of the inventions described in the claims and equivalents of the inventions.

For example, in the embodiment, the information terminal 7 can be attached to the cart 6. However, not only this, but the information terminal 7 may be able to be attached to, for example, a shopping basket (carried by a customer) to put commodities in.

In the embodiment, the server 2 specifies the position of the information terminal 7 based on beacon information emitted from the beacon b. However, not only this, but the server 2 may specify the position of the information terminal 7 with, for example, a publicly-know method using a GPS (Global Positioning System) and a WI-FI (Wireless Fidelity).

In the embodiment, commodity information is once transmitted from the information terminal 7 to the server 2 and then transmitted to the checkout machine 3. However, not only this, but commodity information may be directly transmitted from the information terminal 7 to the checkout machine 3.

In the embodiment, the commodity information transmitted to the server 2 is stored in the commodity information unit 2323 of the information terminal managing unit 232. However, not only this, but the commodity information may be stored in, for example, a customer server that treats information concerning customers.

In the embodiment, the evacuation guidance apparatus 4 is constructed by the server 2 and the information terminal 7. However, not only this, but the evacuation guidance apparatus 4 may be an evacuation guidance system including the server 2 and the information terminal 7.

In the embodiment, information concerning the information terminal 7 that did not substantially move after evacuation guidance route information was transmitted is displayed on the server 2. However, such a function is not essential.

In the embodiment, fire and a robbery are explained as examples of an emergency. However, the emergency may be other than the fire and the robbery.

In the embodiment, the fire alarm 51 and the checkout machine 3 are explained as examples of the emission apparatus. However, not only this, but the emission apparatus may be one of the fire alarm 51 and the checkout machine 3.

In the embodiment, the store T is explained as an example of the commercial facility. However, not only this, but the commercial facility may be, for example, a shopping mall or a shopping facility installed outdoors.

What is claimed is:

1. An evacuation guidance apparatus, comprising:
a server; and
at least one information terminal configured to move in a commercial facility and communicate with the server, wherein
the information terminal includes an emitting component configured to emit specifying information for specifying a position of the information terminal including the emitting component,
the server includes:
a specifying component configured to specify, based on the specifying information, a position of the information terminal in the commercial facility;
a receiving component configured to receive an emergency signal emitted from an emission apparatus;
a determining component configured to, if the emergency signal is received, determine evacuation guidance routes for each of the information terminals based on the specified position of the information terminal; and
a transmitting component configured to transmit evacuation guidance route information including information concerning the determined evacuation guidance routes to the information terminals, and
the information terminal includes a displaying component configured to display, on a display, an evacuation guidance route included in the evacuation guidance route information received from the server.

2. The evacuation guidance apparatus according to claim 1, wherein the specifying component specifies a position of the information terminal based on a position of a beacon in a position where a radio wave of the specifying information emitted by the emitting component is most intensely received among a plurality of beacons disposed in the commercial facility.

3. The evacuation guidance apparatus according to claim 1, wherein the determining component determines an evacuation guidance route from an installation position of the emission apparatus, a position of the information terminal, and a position of an exit of the commercial facility.

4. The evacuation guidance apparatus according to claim 3, wherein the determining component determines the evacuation guidance route to avoid a position of a fire alarm that detected fire and emitted the emergency signal among a plurality of fire alarms installed in the commercial facility.

5. The evacuation guidance apparatus according to claim 1, further comprising:
a movement determining component configured to determine, whether the information terminal moved a predetermined distance or more from a specified position after the evacuation guidance route information was transmitted; and
a specific display component configured to display the information terminal determined by the movement determining component as not having moved the predetermined distance or more.

6. The evacuation guidance apparatus according to claim 1, wherein the specifying component determines the position of the information terminal to avoid a position of an emergency button that emitted the emergency signal based on operation at an emergency time among a plurality of emergency buttons installed in the commercial facility.

7. The evacuation guidance apparatus according to claim 1, comprising at least two information terminals, each information terminal configured to move in the commercial facility and communicate with the server.

8. The evacuation guidance apparatus according to claim 1, comprising at least three information terminals, each information terminal configured to move in the commercial facility and communicate with the server.

9. An evacuation guidance method in an evacuation guidance apparatus including a server and at least one information terminal configured to move in a commercial facility and communicate with the server, comprising:
emitting specifying information for specifying a position of the information terminal; specifying, based on the specifying information emitted, a position of the information terminal in the commercial facility;
determining, if an emergency signal emitted from an emission apparatus is received, evacuation guidance routes for each of the at least one information terminals based on the position of the information terminal specified; and
transmitting evacuation guidance route information including information concerning the evacuation guidance routes determined to the information terminals; and
displaying, on a display, an evacuation guidance route included in the evacuation guidance route information received from the server.

10. The evacuation guidance method according to claim 9, further comprising:
specifying a position of the information terminal based on a position of a beacon in a position where a radio wave of the specifying information emitted is most intensely received among a plurality of beacons disposed in the commercial facility.

11. The evacuation guidance method according to claim 9, further comprising:
determining an evacuation guidance route from an installation position of the emission apparatus, a position of the information terminal, and a position of an exit of the commercial facility.

12. The evacuation guidance method according to claim 11, further comprising:
determining the evacuation guidance route to avoid a position of a fire alarm that detected fire and emitted the emergency signal among a plurality of fire alarms installed in the commercial facility.

13. The evacuation guidance method according to claim 9, further comprising:
determining whether the information terminal moved a predetermined distance or more from a specified position after the evacuation guidance route information was transmitted; and
displaying the information terminal determined as not having moved the predetermined distance or more.

14. The evacuation guidance method according to claim 9, further comprising:
determining the position of the information terminal to avoid a position of an emergency button that emitted the emergency signal based on operation at an emergency time among a plurality of emergency buttons installed in the commercial facility.

15. An evacuation guidance system, comprising:
a server; and
a plurality of information terminals each configured to move in a commercial facility and communicate with the server, wherein
each of the plurality of information terminals includes an emitting component configured to emit specifying information for specifying a position of the information terminal including the emitting component,
the server includes:
a specifying component configured to specify,
based on the specifying information, a position of each of the plurality of information terminals in the commercial facility;
a receiving component configured to receive an emergency signal emitted from an emission apparatus;
a determining component configured to, if the emergency signal is received, determine evacuation guidance routes for each of the plurality of information terminals based on the specified position of each of the plurality of information terminals; and
a transmitting component configured to transmit evacuation guidance route information including information concerning the determined evacuation guidance routes to each of the plurality of information terminals, and
each of the plurality of information terminals includes a displaying component configured to display, on a display, an evacuation guidance route included in the evacuation guidance route information received from the server.

16. The evacuation guidance system according to claim 15, wherein the specifying component specifies a position of each of the plurality of information terminals based on a position of a beacon in a position where a radio wave of the specifying information emitted by the emitting component is most intensely received among a plurality of beacons disposed in the commercial facility.

17. The evacuation guidance system according to claim 15, wherein the determining component determines an evacuation guidance route from an installation position of the emission apparatus, a position of each of the plurality of information terminals, and a position of an exit of the commercial facility.

18. The evacuation guidance system according to claim 17, wherein the determining component determines the evacuation guidance route to avoid a position of a fire alarm that detected fire and emitted the emergency signal among a plurality of fire alarms installed in the commercial facility.

19. The evacuation guidance system according to claim 15, further comprising:
a movement determining component configured to determine, whether each of the plurality of information terminals moved a predetermined distance or more from a specified position after the evacuation guidance route information was transmitted; and
a specific display component configured to display the information terminal determined by the movement determining component as not having moved the predetermined distance or more.

20. The evacuation guidance system according to claim 15, wherein the specifying component determines the position of the each of the plurality of information terminals to avoid a position of an emergency button that emitted the emergency signal based on operation at an emergency time among a plurality of emergency buttons installed in the commercial facility.
